(19) United States
(12) Patent Application Publication
(10) Pub. No.: US 2024/0254928 A1
(43) Pub. Date: Aug. 1, 2024

(54) GAS TURBINE ALLOWING HYDROGEN TO BE USED AS FUEL

(71) Applicant: TOYOTA JIDOSHA KABUSHIKI KAISHA, Toyota-shi (JP)

(72) Inventors: Shigeru HIRANO, Mishima-shi (JP); Yasushi TATEBAYASHI, Fuji-shi (JP)

(73) Assignee: TOYOTA JIDOSHA KABUSHIKI KAISHA, Toyota-shi (JP)

(21) Appl. No.: 18/517,621

(22) Filed: Nov. 22, 2023

(30) Foreign Application Priority Data
Jan. 31, 2023 (JP) 2023-013461

(51) Int. Cl. F02C 9/40; F02C 3/22

(52) U.S. Cl. CPC F02C 9/40; F02C 3/22

(57) ABSTRACT

A gas turbine is configured such that: in a combustor receiving fuel and compressed air, a compressed air quantity supplied to a primary combustion field in the combustor when the rotation speed of a turbine shaft is a predetermined rotation speed is a quantity causing an equivalent ratio at the primary combustion field to be an equivalent ratio allowing misfire to be avoided in an operation state with a predetermined rotation speed and a predetermined load; fuel supply to the combustor is started when rotation of the turbine shaft is started up; a fuel quantity supplied to the combustor is controlled such that the rotation speed of the turbine shaft rises to the predetermined rotation speed, after ignition within the combustor; and increase in a magnitude of the load to the predetermined load is started before the rotation speed of the turbine shaft reaches the predetermined rotation speed.

### CROSS-REFERENCE TO RELATED APPLICATION

This application claims priority to Japanese Patent Application No. 2023-013461 filed on Jan. 31, 2023, incorporated herein by reference in its entirety.

### BACKGROUND

### 1. Technical Field

The present disclosure relates to a gas turbine engine (referred to as a “gas turbine”, hereinafter), and more specifically, relates to control of a gas turbine (hydrogen gas turbine) allowing hydrogen to be used as fuel.

### 2. Description of Related Art

Development research for a heat engine such as a gas turbine in which the fuel is hydrogen has been advanced from the standpoint of global warming prevention and decarbonization. In the case where the fuel is hydrogen, when a combustion field includes a region where fuel concentration is high, combustion temperature becomes high, and NOx generation quantity easily increases. Therefore, for the gas turbine in which the fuel is hydrogen, various configurations in which the region where the fuel concentration is high is not formed in the combustion field of a combustor as much as possible have been studied. For example, Japanese Unexamined Patent Application Publication No. 2016-23916 (JP 2016-23916 A) proposes a configuration for realizing stable combustion in a sequence of operation process from the firing in the gas turbine to the rated load and achieving increase in efficiency, decrease in NOx, and reduction in the number of components. In this configuration, in a gas turbine combustor employing a previous-mixing combustion scheme for uniformizing the temperature of the flame that is formed in a combustion chamber and restraining a NOx discharge quantity by supplying air-fuel mixture in which fuel and air are previously mixed to the combustion chamber, the fuel-air ratio of the previously mixed gas is accurately controlled. Specifically, the literature discloses a configuration provided with: an annular fuel nozzle including an annular pipe in which a plurality of fuel injection holes is formed on a burner for supplying fuel and air to the combustion chamber and a plurality of supply pipes connected to the annular pipe; and an air hole plate that is arranged on the downstream side of the annular fuel nozzle so as to be away from the annular fuel nozzle and on which a plurality of air holes is formed so as to face the plurality of fuel injection holes. Japanese Unexamined Patent Application Publication No. 7-233945 (JP 7-233945 A) proposes a configuration for achieving stable combustion and decrease in NOx discharge in the whole load range for the gas turbine. This configuration includes: a plurality of stages of combustion portions that is disposed at intervals in the axial direction of a combustor of the gas turbine; a plurality of fuel supply systems that is independently coupled to the combustion portions, respectively; a previously-mixed fuel supply portion and a diffusion combustion fuel supply portion that are provided in the fuel supply systems, respectively; and a control device that performs fuel supply for only one of previously-mixed fuel and diffusion combustion fuel by switching between the fuel supply portions. Further, the combustion is started in a diffusion combustion scheme allowing the stable combustion in a wide fuel-air ratio range, and thereafter switching to a previously-mixed combustion scheme is performed. Japanese Unexamined Patent Application Publication No. 2018-194210 (JP 2018-194210 A) proposes an operation method for preventing the generation of unburned gas at the time of start and the time of stop while realizing low NOx combustion in a gas turbine engine combustor that uses high-reactive fuel such as hydrogen. In this operation method, a plurality of fuel injection portions is annularly disposed, main fuel that is high-reactive fuel is injected from some of the plurality of fuel injection portions, and auxiliary fuel that is not high-reactive fuel and the main fuel are injected in a switching manner from some other fuel injection portions. At the time of start, the auxiliary fuel is injected and ignited. Thereafter, the switching to the main fuel is executed, and a rated rotation operation is executed. At the time of stop, the switching from the main fuel to the auxiliary fuel is executed, and the rotation is decelerated. Japanese Unexamined Patent Application Publication No. 2018-4138 (JP 2018-4138 A) proposes that in a combustor of a gas turbine engine having a multistate burner configuration including a main burner for supplying fuel or previously mixed gas to a primary combustion region on the upstream side in the combustion chamber and an additional heating burner for supplying the fuel or previously mixed gas to a secondary combustion region on the downstream side of the primary combustion region in the combustion chamber, for promoting the previous mixing between hydrogen-containing gas injected from the additional heating burner and compressed air, after the fuel and air are injected from an injection hole of the additional heating burner, the air-fuel mixture is caused to pass through a duct having a certain length and then is fed into the combustion chamber, so that the fuel and the air are sufficiently mixed and combusted.

### SUMMARY

As described above, for the combustor of the gas turbine (hydrogen gas turbine) in which the fuel is hydrogen in the related art, typically, the supply structure for the fuel and the compressed air, as exemplified by a combustion nozzle for supplying the fuel and the compressed air to the combustion field, has been improved, in order not to generate the region having the high fuel concentration for restraining the NOx generation quantity. However, as described above, the structure in the related art is a somewhat complicated structure, and the number of components is large. Although a combustor for a middle-size or large-size gas turbine can be configured, in the case of a combustor for a small-size gas turbine, the production is difficult, for example, it is difficult to process and form many minute holes on a small component. Further, when the number of components is large, the benefit of the lightness of the small-size gas turbine is lost. Accordingly, a technique of avoiding the formation of the region having the high fuel concentration in the combustion field without complicating the supply structure for the fuel and the compressed air has an advantage in that it is possible to use the configuration in which the NOx generation quantity is restrained, in various hydrogen gas turbines, regardless of the size.

In the operation of the gas turbine, generally, first, at the time of start-up, while a turbine shaft is rotated by a starter, the fuel supply to the combustor is started, and the ignition is performed. Thereafter, in a state with no load, the fuel quantity is increased, and the rotation speed of the turbine shaft is raised to a predetermined rotation speed, for example, to a rated rotation speed. After the operation state with the predetermined rotation speed and no load is established, the fuel quantity is increased for increasing the load (electricity generation in the case of an electricity generator) to a predetermined load, for example, to a rated load, while the predetermined rotation speed is kept. In this operation technique, the equivalent ratio (fuel quantity/compressed air quantity) at the vicinity (primary combustion field) of a fuel supply site in the combustion field is adjusted such that misfire is avoided in the operation state with the predetermined rotation speed and no load. Therefore, when the fuel quantity is increased and supplied for increasing the load from no load to the predetermined load while the rotation speed is kept at the predetermined rotation speed, the equivalent ratio at the primary combustion field becomes locally high, and the NOx generation quantity increases (in the above related art, the supply structure for the fuel and the compressed air is devised such that the local rise in the equivalent ratio at the primary combustion field is restrained).

When the fuel quantity is increased for increasing the load from no load to the predetermined load as described above, the compressed air quantity that is supplied to the primary combustion field may be increased as a technique for decreasing the equivalent ratio at the primary combustion field for restraining the NOx generation quantity. In this regard, the inventor of the present disclosure has performed the research, and has found the following matter. In the case of the configuration in which the compressed air quantity that is supplied to the primary combustion field is increased such that the equivalent ratio at the primary combustion field can be restrained in the operation state with the predetermined rotation speed and the predetermined load, when the operation state is put into the state with the predetermined rotation speed and no load at the time of the start-up of the gas turbine, the misfire occurs because the equivalent ratio is excessively low. However, the load starts to be given after the ignition is performed in the combustor and before the rotation speed of the turbine shaft reaches the predetermined rotation speed, for example, at the time of about half of the predetermined rotation speed, and thereafter the fuel quantity is controlled such that the rotation speed becomes the predetermined rotation speed and the load becomes the predetermined load. Thereby, it is possible to achieve the operation state with the predetermined rotation speed and the predetermined load, while restraining the increase in the equivalent ratio at the primary combustion field as much as possible. That is, with this operation method, it is possible to restrain the NOx generation quantity, without using the complicated supply structure for the fuel and the air for restraining the local rise in the equivalent ratio at the primary combustion field, unlike the above related art.

Thus, an object of the present disclosure is to reduce the generation quantity or discharge quantity of NOx in the gas turbine in which the hydrogen can be used as the fuel.

Further, another object of the present disclosure is to provide a configuration in which the operation state is controlled such that the operation state with the predetermined rotation speed and the predetermined load is achieved without the misfire at the time of rotation start-up in the above gas turbine having a configuration in which the compressed air quantity that is supplied to the primary combustion field is further increased such that the equivalent ratio at the primary combustion field in the combustor is restrained so as to be lower in the operation state with the predetermined rotation speed and the predetermine load.

With the present disclosure, the above object is a gas turbine. The gas turbine includes: a combustor configured such that fuel and compressed air to be combusted are supplied to the combustor; a fuel supply controller configured to control a fuel quantity that is supplied to the combustor; and a load controller configured to control the magnitude of the load that acts on a turbine shaft. A compressed air quantity that is supplied to a primary combustion field in the combustor when the rotation speed of the turbine shaft is a predetermined rotation speed is a quantity that causes an equivalent ratio at the primary combustion field to be an equivalent ratio that allows misfire to be avoided in an operation state with a predetermined rotation speed and a predetermined load. The fuel supply controller is configured to start fuel supply to the combustor when rotation of the turbine shaft is started up, and the fuel supply controller is configured to control the fuel quantity that is supplied to the combustor, such that the rotation speed of the turbine shaft rises to the predetermined rotation speed, after ignition within the combustor. The load controller is 20 configured to start increase in the magnitude of the load to the predetermined load, before the rotation speed of the turbine shaft reaches the predetermined rotation speed.

In the above configuration, the “gas turbine” may be an arbitrary type of gas turbine in which a compressor, a turbine, and a load apparatus on which the load acts, as exemplified by an electricity generator, are coupled to a turbine shaft. The “combustor” may be an arbitrary type of combustor such as a can type and an annular type, for example. The compressed air quantity that is supplied to the primary combustion field in the combustor when the rotation speed of the turbine shaft is the predetermined rotation speed is adjusted so as to meet the condition of the quantity that causes the equivalent ratio at the primary combustion field to be the equivalent ratio that allows the misfire to be avoided in the operation state with the predetermined rotation speed and the predetermined load, as described above. The “predetermined rotation speed” may be a rotation speed that can be appropriately set based on experiments and the like and at which the gas turbine rotates stably or efficiently, and may be a “rated rotation speed” (a rated value of the rotation speed) that is a rotation speed at the time of an ordinary operation of the gas turbine. The “predetermined load” may be a magnitude of the load that can be appropriately set based on experiments and the like and at which the gas turbine performs output stably or efficiently, and may be a “rated load” (a rated value of the load) that is a load at the time of the ordinary operation of the gas turbine. As described already, the “primary combustion field” is a combustion field on the upstream side within the combustion chamber of the combustor, and means a region at the vicinity of a fuel supply site such as a fuel injection hole. The specific range of the primary combustion field, which differs depending on the shape of the combustion chamber, may be approximately a range from an upstream edge of the flame due to the combustion of the fuel and the compressed air on the upstream side along a gas flow direction within the combustion chamber to a site where additional compressed air is supplied on the downstream side along the gas flow direction (ordinarily, the compressed air is supplied into the combustion chamber at a plurality of stages along the gas flow direction within the combustion chamber). Further, the adjustment of the compressed air quantity that is supplied to the primary combustion field is achieved by appropriately adjusting the bore of a supply port for feeding the compressed air to the primary combustion field. The “fuel supply controller” may be means for adjusting the fuel quantity that is supplied into the combustion chamber, by an arbitrary scheme. The “load controller” may be means for controlling the magnitude of the load (work quantity or work rate) that acts on the turbine shaft, by an arbitrary scheme. In the case where the gas turbine is used as a dynamic power source of an electricity generator, the load may be the electricity generation quantity or generated electric power that is output to the electricity generator, and the load controller may be means for adjusting the electricity generation quantity or generated electric power for the electricity generator.

In the above configuration in the present disclosure, when the rotation of the turbine shaft is started up, the fuel supply controller starts the fuel supply to the combustor. When the air-fuel mixture of the fuel and the compressed air is ignited within the combustor, the fuel supply controller performs control to increase the fuel quantity that is supplied to the combustor, such that the rotation speed of the turbine shaft rises to the predetermined rotation speed. Meanwhile, the load controller is actuated so as to increase the magnitude of the load to the predetermined load, before the rotation speed of the turbine shaft reaches the predetermined rotation speed (which may be the rated rotation speed). In this case, the load starts to be applied to the turbine shaft before the rotation speed of the turbine shaft reaches the predetermined rotation speed. Therefore, the fuel quantity for raising the rotation speed of the turbine shaft is larger than that at the time of no load, and the operation state of the gas turbine transitions to the state with the predetermined rotation speed and the predetermined load that are used at an ordinary actuation, without transitioning to the state with the predetermined rotation speed and no load. Thereby, in the present disclosure, it is not necessary to secure a high equivalent ratio for preventing the misfire in the state with the predetermined rotation speed and no load at the primary combustion field, and it is possible to decrease the equivalent ratio by putting in a larger quantity of compressed air, so that it is possible to restrain the generation quantity of NOx. Further, it should be understood that the restraint of the NOx generation quantity can be achieved without using complicated supply structures for the fuel and the air that are proposed in the above prior documents. In the above configuration in the present disclosure, as described already, the fuel quantity until the rotation speed reaches the predetermined rotation speed is large. However, in the case where the load apparatus coupled to the turbine shaft is an electricity generator, the energy of the fuel quantity until the rotation speed reaches the rated rotation speed is converted into electric power energy, and electricity storage or the like can be performed. Therefore, the loss until the rotation speed reaches the predetermined rotation speed is expected to be not very large.

In the above configuration in the present disclosure, for preventing the rotation of the turbine shaft from becoming unstable due to the start of the load action when the load controller causes the load to act before the rotation speed of the turbine shaft reaches the predetermined rotation speed, the load controller may be configured to start the increase in the magnitude of the load when the rotation speed of the turbine shaft becomes a rotation speed that allows the load to act on the turbine shaft. Further, in order that the rotation of the turbine shaft does not become unstable, the fuel supply controller may be configured to control the fuel quantity that is supplied to the combustor, such that the rotation speed of the turbine shaft does not decrease after rotation is started and before the rotation speed of the turbine shaft reaches the predetermined rotation speed. Specifically, the fuel supply controller may be configured to control the fuel quantity while referring to the rotation speed of the turbine shaft, such that the rotation speed of the turbine shaft gradually increases to the predetermined rotation speed.

Further, in the above configuration, as described already, at the time of the start-up of the gas turbine, the operation state of the gas turbine transitions to the state with the predetermined rotation speed and the predetermined load, without transitioning to the state with the predetermined rotation speed and no load. Therefore, it is possible to reduce the equivalent ratio at the primary combustion field when the rotation speed of the turbine shaft is the predetermined rotation speed, within a range in which the misfire is avoided at the time of the predetermined load, and thereby it is possible to restrain the NOx generation quantity as much as possible. Accordingly, in the above configuration in the present disclosure, the compressed air quantity that is supplied to the primary combustion field in the combustor when the rotation speed of the turbine shaft is the predetermined rotation speed may be a quantity that causes the equivalent ratio at the primary combustion field to be an available lower limit of the equivalent ratio that allows the misfire to be avoided in the operation state with the predetermined rotation speed and the predetermined load. That is, the compressed air quantity may be maximized within an available range in which the misfire is avoided in the operation state with the predetermined rotation speed and the predetermined load.

The above configuration in the present disclosure is suitably applied in the case where hydrogen is used as the fuel of the gas turbine. Therefore, the fuel may be hydrogen, but is not limited to this.

Thus, put simply, in the above gas turbine in the present disclosure, since the operation state transitions to the state with the predetermined rotation speed and the predetermined load without transitioning to the state with the predetermined rotation speed and no load, it is possible to reduce the equivalent ratio in the state with the predetermined rotation speed and the predetermined load, and to reduce the NOx generation quantity, as described already. What is important is that the NOx generation quantity is expected to be reduced in the configuration in the present disclosure by improving the operation process at the time of the start-up of the gas turbine, without requiring a complicated improvement of the supply site for the fuel and the compressed air. Therefore, it should be understood that the configuration in the present disclosure can be applied even to a small-size gas turbine for which it is difficult to realize a complicated structure, regardless of the size of the gas turbine. The gas turbine in the present disclosure can be utilized as a small-size gas turbine that can be equipped in a vehicle such as an automobile and in which hydrogen is used as the fuel, and thereby the hydrogen gas turbine is expected to spread over a wider range.

Other purposes and advantages of the present disclosure will become clear in the following description about preferred embodiments of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view of a gas turbine according to an embodiment;

FIG. 1B is a diagram showing the configuration of a control device of the gas turbine as a block diagram;

FIG. 2 is a diagram schematically showing a change in a combustion temperature T with respect to an equivalent ratio (fuel quantity/compressed air quantity) F/A;

FIG. 3A is a diagram schematically showing a change in the equivalent ratio F/A with respect to increase in a rotation speed Rpm of a turbine shaft at the time of the start-up of the gas turbine, and shows a case of a general conventional operation technique;

FIG. 3B is a diagram schematically showing a change in the equivalent ratio F/A with respect to increase in the rotation speed Rpm of the turbine shaft at the time of the start-up of the gas turbine, and shows a case of an operation technique according to the embodiment; and

FIG. 4 is a diagram showing a processing stage at the time of start-up operation of the gas turbine according to the embodiment as a flowchart.

### DETAILED DESCRIPTION OF EMBODIMENTS

### Basic Configuration of Gas Turbine

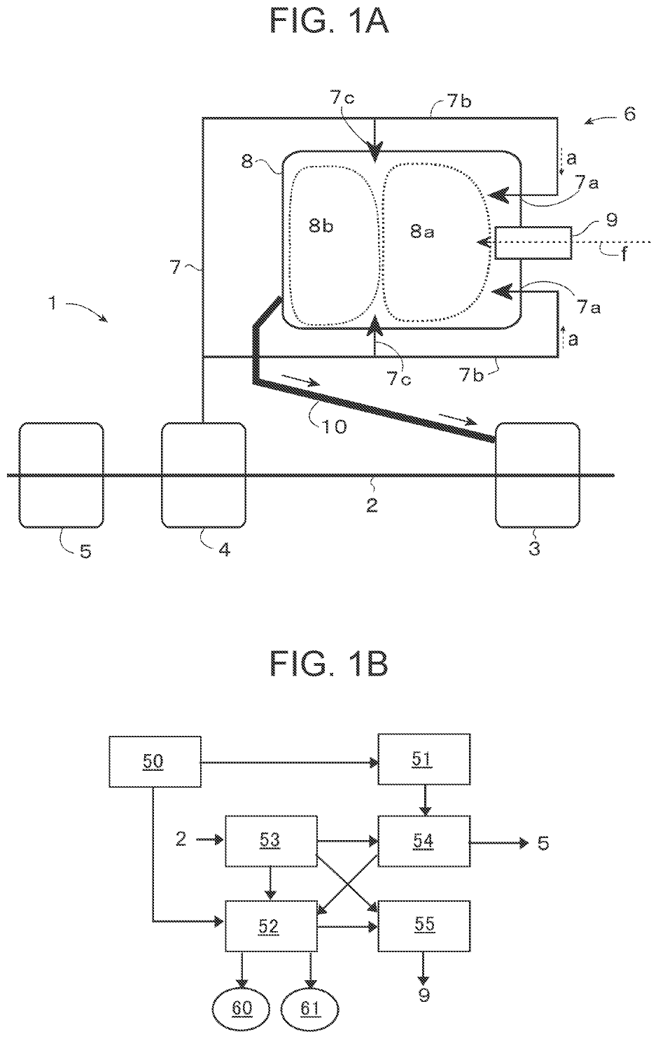

A configuration in an embodiment can be applied to various gas turbines. As shown in FIG. 1A, in a basic configuration, a gas turbine 1 may include a turbine 3, a compressor 4, a load apparatus 5 such as an electricity generator, and a combustor 6 that are coupled to a turbine shaft 2. In a basic actuation, air (compressed air) a compressed in the compressor 4 by the rotation of the turbine shaft 2 is fed to a combustion chamber 8 of the combustor 6 through a flow passage 7, and in the combustion chamber 8, is mixed with fuel f from a fuel supply device 9, to be combusted. The combusted gas is fed to the turbine 3 through a combusted gas flow passage 10, and rotates the turbine shaft 2. Thereby, the compression of the air in the compressor 4 and the actuation of the load apparatus 5, for example, the electricity generation due to the rotation of a rotator of the electricity generator are executed. Further, as to the combustor 6, more specifically, for better combustion of the fuel and the air, typically, the compressed air a is fed into the combustion chamber 8 in a plurality of steps. Specifically, some of the compressed air a is injected from a supply port 7a at the vicinity (a right-side region in the combustion chamber in the figure; a primary combustion field 8a) of a supply port for the fuel f of a fuel device 9, and is mixed with the fuel f in various ways. Some other compressed air a is released from a supply port 7c to a region (secondary combustion field 8b) on the downstream side of the primary combustion field 8a. The fuel that is supplied to the combustor 6 may be hydrogen (the fuel is not limited to this). In this regard, in the gas turbine to which the embodiment is applied, even when the fuel is hydrogen, the specific structure of the combustor 6 may be an arbitrary structure, for example, a conventional structure in which fossil fuel is used as the fuel, and special configurations described in the above patent literatures are not essential.

### Configuration of Control Device of Gas Turbine

The control of the gas turbine in FIG. 1A may be executed by a control device as schematically shown in FIG. 1B. The control device may be an ordinary type of computer device including a CPU, a ROM, a RAM, and an input-output port device that are mutually coupled by bidirectional common paths, and the configuration and actuation of each later-described unit in the embodiment may be realized by the actuation of the computer device in accordance with a program.

In the control device, specifically, as shown in FIG. 1B, a turbine actuation command unit 50, a load request unit 51, a rotation speed control unit 52, a rotation speed detection unit 53, a load control unit 54, a fuel quantity control unit 55, and the like may be configured. More specifically, the turbine actuation command unit 50 may be configured to give a control command for an instruction of the actuation of the gas turbine, to the load request unit 51 and the rotation speed control unit 52, based on an instruction from a user and the like or a request from arbitrary equipment. The request or instruction that is given to the turbine actuation command unit 50 may be a request or instruction for operating the gas turbine at a predetermined rotation speed and predetermined load that may be appropriately set. The predetermined rotation speed may be a “rated rotation speed” that is set such that the gas turbine rotates stably or efficiently, but is not limited to this. The “load” is a work that is given to the load apparatus 5 through the turbine shaft 2 of the gas turbine 1, and may be expressed as a work rate per unit electric power in the case where the load apparatus 5 is an electricity generator. The “predetermined load” may be a “rated load” that is set such that the gas turbine performs output stably or efficiently, but is not limited to this.

The load request unit 51 may be configured to receive the control command from the turbine actuation command unit 50, to set a target value (target load value) of the magnitude of the load that is generated by the gas turbine, and to send the target value to the load control unit 54. The target load value may be the predetermined load in the instruction from the turbine actuation command unit 50. The rotation speed detection unit 53 may be configured to detect the rotation speed of the turbine shaft 2 using an arbitrary type of sensor, and to send the detected value to each unit.

The load control unit 54 may be configured to refer to the target load value from the load request unit 51 and the detected rotation speed value from the rotation speed detection unit 53, to decide a requested value (requested load value) of the magnitude of the load that needs to be given to the load apparatus at the current turbine rotation speed (detected rotation speed value), within a range in which the requested value does not exceed the target load value, and to send a control command for causing the load apparatus 5 to absorb a work corresponding to the requested load value, to the load apparatus 5.

Put briefly, the rotation speed control unit 52 is configured to refer to the control command from the turbine actuation command unit 50, the detected rotation speed value from the rotation speed detection unit 53, and the requested load value from the load control unit 54, and to execute the setting of a target value (target rotation speed value) of the rotation speed to be reached in the gas turbine based on the control command from the turbine actuation command unit 50, the start-up and stop of a starter 60, the instruction of fuel supply to the fuel quantity control unit, and the instruction of ignition to an igniter 61. On this occasion, the target rotation speed value may be the predetermined rotation speed in the instruction from the turbine actuation command unit 50. Further, the starter 60 may be controlled so as to be started up in response to the instruction of actuation start from the turbine actuation command unit 50 and to be stopped when the ignition by the igniter is executed. As to the instruction of fuel supply to the fuel quantity control unit 55, specifically, first, the requested value (requested rotation speed value) of the rotation speed that needs to be currently generated in the turbine shaft may be decided based on the detected rotation speed value of the turbine shaft 2 and the requested load value, and the requested rotation speed value may be given as the control command for the fuel supply to the fuel quantity control unit 55.

The fuel quantity control unit 55 may be configured to compare the detected rotation speed value and the requested rotation speed value, and to control the fuel quantity that is supplied from the fuel supply device 9, such that the detected rotation speed value coincides with the requested rotation speed value.

Relation between Combustion Temperature and NOx Generation Quantity

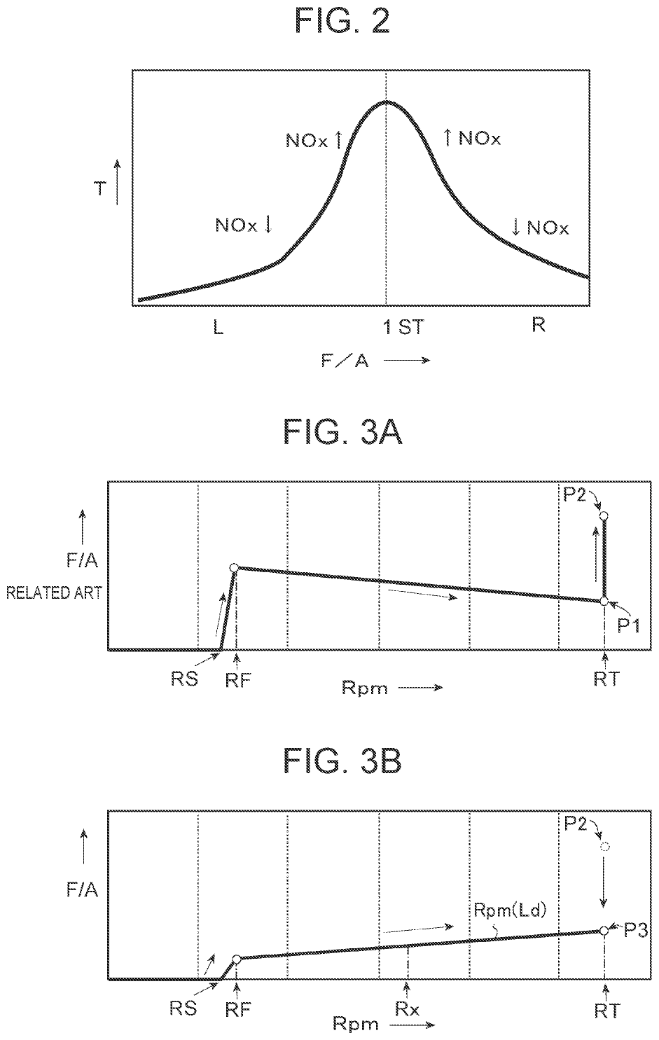

As understood by a person skilled in the art, when the combustion temperature of the fuel and the compressed air within the combustion chamber rises, the NOx generation quantity increases. As shown in FIG. 2, when an equivalent ratio F/A is a stoichiometric air-fuel ratio (ST), a combustion temperature T is highest, and as the equivalent ratio F/A is lower than the stoichiometric air-fuel ratio (lean: L) or as the equivalent ratio F/A is higher than the stoichiometric air-fuel ratio (rich: R), the combustion temperature T decreases and the NOx generation quantity decreases. Accordingly, in the actuation of the gas turbine, it is desirable that there is as little fuel as possible, and therefore, for restraining the NOx generation quantity, it is desirable to combust the fuel and the compressed air in a lean state where the equivalent ratio is lower. Particularly, in the case where the fuel is hydrogen, the combustion temperature is high, and therefore, for restraining the NOx generation quantity, it is desired that the equivalent ratio is as low as possible within a range in which the misfire is avoided.

### Operation State at Time of Start-up of Gas Turbine

### (1) Conventional Operation Technique at Time of Start-up of Gas Turbine

As described in SUMMARY, in the conventional operation technique at the time of the start-up of the gas turbine 1, generally, in the state with no load, the turbine rotation speed is raised to a rated rotation speed (a predetermined rotation speed that is ordinarily used at the time of the operation of the gas turbine), and thereafter the load is increased. At this time, the fuel supply quantity is increased while the rated rotation speed is kept. Specifically, at the time of the start-up of the gas turbine 1, as illustrated in FIG. 3A, first, the rotation of the turbine shaft 2 is started up by the starter 60, and the supply of the compressed air a into the combustion chamber 8 is started. In the case where a mechanism for causing the flow to escape, or the like is not provided in the middle of a flow passage 7b, the supply quantity of the compressed air increases so as to correspond to the increase in the rotation speed of the turbine shaft 2. Then, when the rotation speed Rpm reaches RS, the fuel supply is started. When the rotation speed Rpm further reaches RF, the igniter 61 is actuated, and the combustion of the fuel and the air is started. Thereafter, as shown in the figure, in the state with no load (in the state where the load apparatus 5 is caused not to work), the fuel supply quantity is gradually increased until the rotation speed Rpm increases to the rated rotation speed RT. The reason why the equivalent ratio F/A decreases until the rotation speed Rpm reaches RT from RS in the figure is because the increase rate of the compressed air quantity is higher than the increase rate of the fuel quantity. Thereafter, when the load apparatus 5 is caused to work, while the rated rotation speed RT is kept (P1), the fuel supply quantity is increased, and the load is increased until the load reaches a rated load (a predetermined load that is ordinarily used at the time of the operation of the gas turbine) (P2).

In the case of the conventional operation technique described above with FIG. 3A, the operation state is put into the state P1 with the rated rotation speed and no load once, and then is caused to transition to the state P2 with the rated rotation speed and the rated load, and therefore it is necessary to secure a sufficient equivalent ratio F/A for avoiding the misfire at the primary combustion field 8a in the state P1 with the rated rotation speed and no load. That is, it is necessary to restrain the compressed air quantity that is put in the primary combustion field 8a (the compressed air quantity that is supplied from the supply port 7a), within the range in which the misfire is avoided in the state P1 with the rated rotation speed and no load. Therefore, in that state, when the fuel supply quantity is increased for increasing the load to the rated load, the equivalent ratio F/A at the primary combustion field 8a increases so as to correspond to the increase in the fuel supply quantity, and the combustion temperature rises, so that the NOx generation quantity increases.

### (2) Operation Technique at Time of Start-up of Gas Turbine in Embodiment

The NOx generation quantity in a state (for example, the state with the rated rotation speed and the rated load) with a predetermined rotation speed and a predetermined load that are ordinarily used at the time of the operation of the above gas turbine can be restrained so as to be lower by increasing the air quantity that is supplied to the primary combustion field 8a and reducing the equivalent ratio F/A at the primary combustion field 8a. In this regard, the research by the inventor of the embodiment has revealed the following matter. In the case of the configuration in which the air quantity that is supplied to the primary combustion field 8a is increased such that the equivalent ratio F/A at the primary combustion field 8a can be restrained in the operation state with the predetermined rotation speed and the predetermined load as much as possible, when the operation state is put into the state with the predetermined rotation speed and no load at the time of the start-up of the gas turbine 1, the misfire occurs because the equivalent ratio F/A is excessively low. However, the actuation (the increase in the load) of the load apparatus is started after the ignition is performed in the combustion chamber 8 and before the rotation speed of the turbine shaft 2 reaches the predetermined rotation speed (for example, at the time of about half of the rated rotation speed RT), and thereafter the fuel quantity is controlled such that the rotation speed becomes the predetermined rotation speed and the load becomes the predetermined load. Thereby, it is possible to achieve the operation state with the predetermined rotation speed and the predetermined load. That is, at the time of the start-up of the gas turbine 1, instead of putting the operation state into the state with the predetermined rotation speed and no load once as in the case of the conventional operation technique, the increase in the load is started at the time when the rotation speed of the turbine shaft 2 reaches a rotation speed allowing the giving (the actuation of the load apparatus) of the load, and thereafter the operation state is directly put into the state with the predetermined rotation speed and the predetermined load. Thereby, it is possible to further increase the air quantity that is supplied to the primary combustion field 8a for further restraining the equivalent ratio F/A at the primary combustion field 8a in the operation state with the predetermined rotation speed and the predetermined load.

Thus, put simply, in the embodiment, in the combustor 6, the compressed air quantity that is supplied to the primary combustion field 8a is increased within the range of the satisfaction of the equivalent ratio F/A that allows the misfire to be avoided at the primary combustion field 8a in the operation state with the predetermined rotation speed and the predetermined load. At the time of the start-up of the gas turbine 1, the increase in the load is started at the time when the rotation speed of the turbine shaft 2 reaches the rotation speed allowing the giving of the load, and the operation state is controlled so as to directly transition to the state with the predetermined rotation speed and the predetermined load. For example, the increase in the compressed air quantity that is supplied to the primary combustion field 8a may be achieved by enlarging the bore of a supply port for the compressed air that is opened toward the primary combustion field 8a. In the actual configuration, the compressed air quantity that is supplied to the primary combustion field 8a at the predetermined rotation speed may be set by adaptation. Preferably, the compressed air quantity that is supplied to the primary combustion field 8a at the predetermined rotation speed may be set to a quantity that gives an available lower limit (the value may be higher to some extent than the lower limit of the equivalent ratio that allows the misfire to be avoided, in consideration of the stability of the control) of the equivalent ratio that allows the misfire to be avoided in the state with the predetermined rotation speed and the predetermined load, for restraining the NOx generation quantity as much as possible.

Specifically, the operation control at the time of the start-up of the gas turbine 1 according to the embodiment may be executed as shown in FIG. 3B. With reference to the figure, first, when the start-up of the gas turbine is commanded, the rotation of the turbine shaft 2 is started up by the starter 60, and the supply of the compressed air a into the combustion chamber 8 is started. When the rotation speed Rpm reaches RS, the fuel supply is started. When the rotation speed Rpm further reaches RF, the igniter 61 is actuated, and the combustion of the fuel and the air is started. The reason why the equivalent ratio at the time of the ignition is lower than that in the case of FIG. 3A is because the compressed air quantity that is supplied to the primary combustion field 8a is relatively larger. Thereafter, the fuel supply quantity is increased such that the rotation speed Rpm and the equivalent ratio F/A increase, and when the rotation speed reaches Rx, the actuation for causing the load apparatus to work is started. Thereafter, the fuel supply quantity is increased such that the rotation speed Rpm and the equivalent ratio F/A increases and becomes a state P3 with the predetermined rotation speed and the predetermined load, as shown by a solid line in the figure. In this process of the start-up of the gas turbine, for the stability of the rotation of the gas turbine, preferably, the fuel supply quantity may be controlled such that the rotation speed does not decrease after the rotation is started and before the rotation speed reaches the predetermined rotation speed. Further, in the control of the transition of the operation state to the state P3 with the predetermined rotation speed and the predetermined load after the ignition, the fuel supply quantity may be controlled such that the requested load value for the load apparatus is gradually increased for avoiding rapid increase and the rotation speed is gradually increased depending on the requested load value. With this operation technique, as shown in the figure, it is possible to reduce the equivalent ratio in the state with the predetermined rotation speed and the predetermined load, from P2 to P3, and accordingly to restrain the NOx generation quantity.

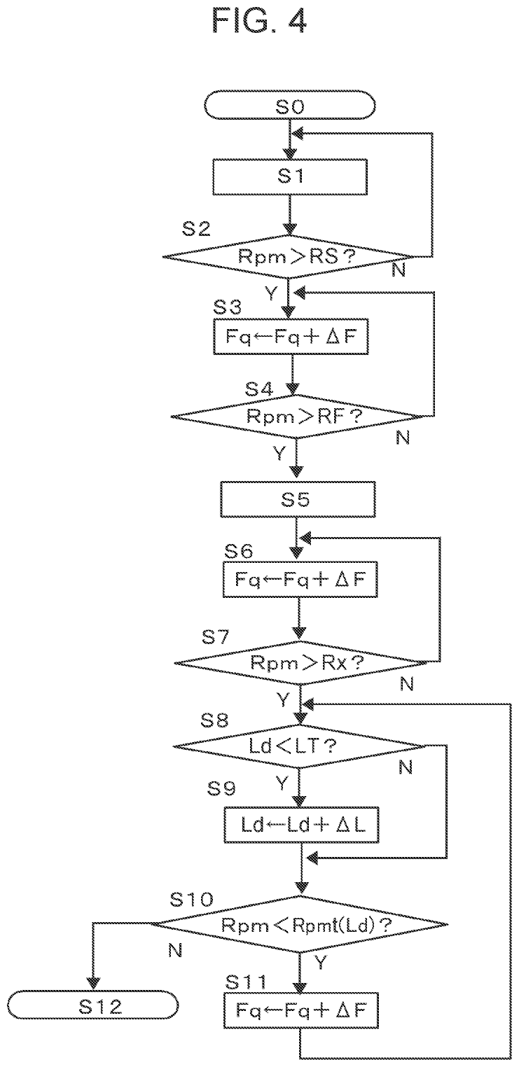

In a specific control process at the time of the start-up of the gas turbine 1 according to the embodiment, for example, as shown in FIG. 4, when the instruction of the start-up of the gas turbine 1 is given (S0), the rotation of the turbine shaft 2 is started by the starter 60 (S1). When the rotation speed Rpm reaches RS (S2), the fuel supply is started (S3). For example, a fuel supply quantity Fq may be gradually increased by an increment ΔF that may be appropriately set, until the rotation speed Rpm reaches RF (S4). When the rotation speed Rpm reaches RF (S4), the ignition of the air-fuel mixture of the fuel and the compressed air is executed, the actuation of the starter 60 is stopped (S5), and the turbine 3 is rotated by the combustion gas from the combustor 6 that is generated by the combustion, so that the rise in the rotation speed Rpm is started. Thereafter, the fuel supply quantity Fq increases, and thereby the rotation speed Rpm rises. When the rotation speed Rpm reaches Rx lower than the predetermined rotation speed (for example, the rated rotation speed) RT that is the target value of the rotation speed, the increase in a load Ld is executed until the load Ld reaches a predetermined load LT that is the target value of the load (S8, S9). For example, the load Ld may be gradually increased by an increment ΔL that may be appropriately set. Then, the fuel supply quantity Fq is increased (S11), such that the rotation speed Rpm coincides with a requested rotation speed value Rpmt(Ld) that is set so as to correspond to the load Ld (S10). Rpmt(Ld) may be set so as to become the predetermined rotation speed RT (=Rpmt(LT)) when the load Ld reaches the predetermined load LT. Thereby, the operation state of the gas turbine is controlled so as to become the state with the predetermined rotation speed and the predetermined load (S12).

Thus, in the above gas turbine in the embodiment, at the time of the start-up of the gas turbine, the increase in the load is started before the rotation speed reaches the predetermined rotation speed. The operation state is caused to directly transition to the state with the predetermined rotation speed and the predetermined load, and the operation in the state with the predetermined rotation speed and no load is not executed. This eliminates the restriction of the supply quantity of the compressed air for meeting the equivalent ratio that needs to be secured for avoiding the misfire in the state with the predetermined rotation speed and no load, and it is possible to increase the compressed air supply quantity for avoiding the misfire in the state with the predetermined rotation speed and the predetermined load. Therefore, it is possible to sufficiently reduce the equivalent ratio in the state with the predetermined rotation speed and the predetermined load, and to reduce the NOx generation quantity. It should be understood that the embodiment may be used for an arbitrary type of gas turbine and does not require a complicated structure for preventing the non-uniformity of combustion concentration at the primary combustion field.

The above description has been made about the embodiment of the present disclosure, but it is clear that a person skilled in the art can easily perform many modifications and alterations and the present disclosure is not limited to only the embodiment exemplified above and can be applied to various devices without departing from the concept of the present disclosure.

What is claimed is:

1. A gas turbine comprising:
a combustor configured such that fuel and compressed air to be combusted are supplied to the combustor;
a fuel supply controller configured to control a fuel quantity that is supplied to the combustor; and
a load controller configured to control a magnitude of a load that acts on a turbine shaft, wherein:
a compressed air quantity that is supplied to a primary combustion field in the combustor when a rotation speed of the turbine shaft is a predetermined rotation speed is a quantity that causes an equivalent ratio at the primary combustion field to be an equivalent ratio that allows misfire to be avoided in an operation state with a predetermined rotation speed and a predetermined load;
the fuel supply controller is configured to start fuel supply to the combustor when rotation of the turbine shaft is started up;
the fuel supply controller is configured to control the fuel quantity that is supplied to the combustor, such that the rotation speed of the turbine shaft rises to the predetermined rotation speed, after ignition within the combustor; and
the load controller is configured to start increase in the magnitude of the load to the predetermined load, before the rotation speed of the turbine shaft reaches the predetermined rotation speed.

2. The gas turbine according to claim 1, wherein the load controller is configured to start the increase in the magnitude of the load when the rotation speed of the turbine shaft becomes a rotation speed that allows the load to act on the turbine shaft.

3. The gas turbine according to claim 1, wherein the fuel supply controller is configured to control the fuel quantity that is supplied to the combustor, such that the rotation speed of the turbine shaft does not decrease after rotation is started and before the rotation speed of the turbine shaft reaches the predetermined rotation speed.

4. The gas turbine according to claim 1, wherein the compressed air quantity that is supplied to the primary combustion field in the combustor when the rotation speed of the turbine shaft is the predetermined rotation speed is a quantity that causes the equivalent ratio at the primary combustion field to be an available lower limit of the equivalent ratio that allows the misfire to be avoided in the operation state with the predetermined rotation speed and the predetermined load.

5. The gas turbine according to claim 1, wherein the fuel is hydrogen.
